(19) United States
(12) Patent Application Publication
(10) Pub. No.: US 2008/0002316 A1
(43) Pub. Date: Jan. 3, 2008

(54) POWER CLAMP DEVICES WITH VERTICAL NPN DEVICES

(76) Inventors: James W. Adkisson, Jericho, VT (US); John J. Ellis-Monaghan, Grand Isle, VT (US); Steven H. Voldman, South Burlington, VT (US)

Correspondence Address: HOFFMAN, WARNICK & D'ALESSANDRO LLC, 75 STATE ST, 14TH FLOOR, ALBANY, NY, 12207, US

(21) Appl. No.: 11/427,063

(22) Filed: Jun. 28, 2006

(51) Int. Cl. H02H 9/00

(52) U.S. Cl. 361/56

(57) ABSTRACT

ESD power clamp devices with vertical NPN devices are disclosed. The power clamp is formed on an N type substrate and includes an N channel field effect transistor (NFET). The source and drain regions of the NFET, a P type epitaxial region under the NFET, and the N type substrate constitutes two vertical NPN devices. As such, vertical interactions of electrons are enabled to avoid the disadvantages of traditional power clamps, e.g., minority carrier cross-talk.

### FIELD OF THE INVENTION

The invention relates generally to on-chip electrostatic discharge (ESD) protection, and more particularly to an ESD power clamp with a vertical NPN structure.

### BACKGROUND ART

As the integrated circuit (IC) processing technology sizes, an IC connected to external ports becomes more susceptible to electrostatic discharge (ESD) pulses from, e.g., the operating environment. Approaches to solve the ESD problems include zener diodes, metal oxide varistors (MOVs), transient voltage suppression (TVS) diodes, and regular complementary metal oxide semiconductor (CMOS) or bipolar clamp diodes, among which an ESD power clamp design has become popular since 1990's, because it can achieve both functional and ESD advantages. FIG. 1 shows a prior art resistor-capacitor (RC) triggered power clamp 10, including a metal oxide semiconductor field effect transistor (MOSFET) 12 and a triggering circuit 14 both coupled in parallel between a positive power supply (VDD) 16 and a ground (GND) 18. Triggering circuit 14 includes a resistor 22 and a capacitor 24 coupled in series. An inverter chain 20 including an odd number of inverters (here three) is coupled between the gate of MOFET 12 and an interconnect 23 between resistor 22 and capacitor 24 of resistor-capacitor series 14.

To date, all power clamp designs focus on dual well complementary metal oxide semiconductor (CMOS) with a P type substrate region. The traditional power clamps, e.g., power clamp 10 of FIG. 1, have some disadvantages. For example, for image processing chips with a traditional power clamp, electron flows in the P type substrate would be propagated from one pixel to another leading to a “blooming effect” or minority carrier cross-talk between pixels. In addition, traditional power clamps do not provide a good solution to the negative polarity ESD events that are potentially involved with CMOS image sensor technologies. One reason that causes the disadvantages of traditional power clamps is that electrons only move/interact among regions within the surface of the active area of MOSFET 12 of FIG. 1. There is no vertical interaction of electrons within MOSFET 12.

### SUMMARY OF THE INVENTION

ESD power clamp devices with vertical NPN devices are disclosed. The power clamp is formed on an N type substrate and includes an N-channel field effect transistor (NFET). The source and drain diffusion regions of the NFET, a P-type epitaxial region under the NFET, and the N type substrate constitutes two vertical NPN devices, respectively. As such, vertical interactions of electrons are enabled to avoid the disadvantages of traditional power clamps, e.g., minority carrier cross-talk.

A first aspect of the invention provides a structure in a power clamp system, the structure comprising: a planar n-channel field effect transistor (NFET) on a surface of the structure; a P-type epitaxial region under a P-type channel region of the NFET; and an N-type substrate under the P-type epitaxial region; wherein a diffusion region of the NFET, the P-type epitaxial region, and the N-type substrate constitute a vertical NPN device.

A second aspect of the invention provides a method of protecting a target circuit from an electrostatic discharge (ESD), the method comprising: coupling a power clamp system between a first power rail and a second power rail in parallel to the target circuit, the power clamp system including: an n-channel field effect transistor (NFET), a source pin and a drain pin of the NFET electrically coupled to the first power rail and the second power rail, respectively; and a first vertical NPN device coupled between one of the source pin and the drain pin of the NFET and a third power rail.

A third aspect of the invention provides a power clamp system, the power clamp system comprising: an n-channel field effect transistor (NFET), a source pin and a drain pin of the NFET electrically coupled to the first and the second power rails, respectively; and a first vertical NPN device coupled between one of the source pin and the drain pin of the NFET and a third power rail. The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a traditional RC triggered power clamp.

FIG. 2 shows a circuit structure of a power clamp according to one embodiment of the invention.

FIG. 3 shows a cross-sectional view of an N channel field effect transistor (NFET) within the power clamp of FIG. 2 according to one embodiment of the invention.

FIG. 4 shows an alternative embodiment of a power clamp according to one embodiment of the invention.

FIG. 5 shows a cross-sectional view of the power clamp of FIG. 4 according to one embodiment of the invention.

FIG. 6 shows another alternative embodiment of a power clamp according to one embodiment of the invention.

FIG. 7 shows a cross-sectional view of the power clamp of FIG. 6 according to one embodiment of the invention.

FIG. 8 shows a circuit structure of an implementation of the power clamps according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

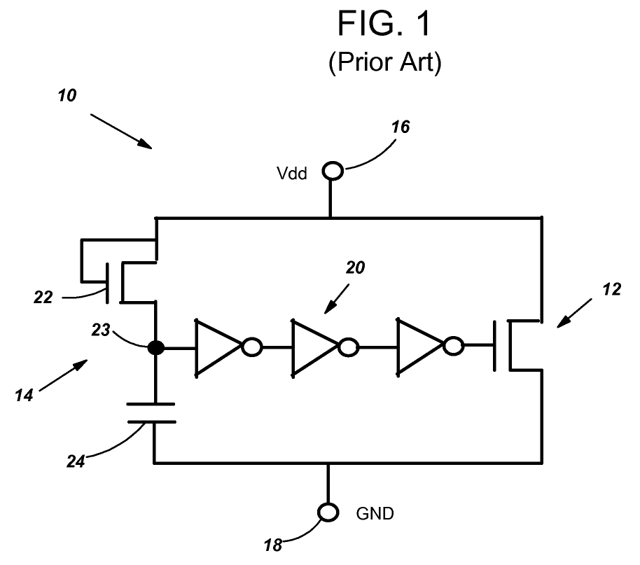

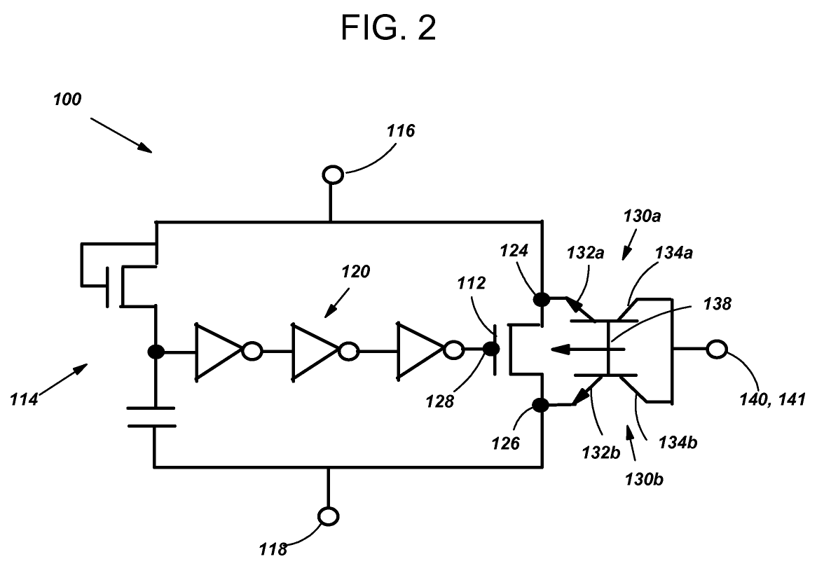

Turning to the drawings, FIG. 2 shows a circuit structure of an RC triggered power clamp 100 according to one embodiment of the invention. In contrast to the traditional power clamp 10 of FIG. 1, power clamp 100 includes an N channel field effect transistor, e.g., MOSFET, 112 that is coupled to two vertical NPN devices (NPN) 130a, 130b. Specifically, collectors 132a, 132b of NPN devices 130a, 130b, respectively, are connected/electrically short to source pin 124 and drain pin 126 of MOSFET 112, respectively. Emitters 134a, 134b of NPN devices 130a, 130b are coupled/electrically short to an N type substrate 140. Bases of NPN devices 130a, 130b are coupled together to form a base node 138. Substrate 140 is coupled to a substrate power rail 141.

It should be noted that power supplies 116, 118 can be any pair of power supplies of different potentials. For example, power supplies 116 and 118 may be Vcc and Vss, Vdd and GND, or even GND and Vee, respectively. According to one embodiment, the potential of power supply 116 is higher than the potential of power supply 118. As such, in the following description, a “first power rail” is used to refer power supply 116, and a “second power rail” is used to refer power supply 118. Similarly, substrate power rail 141 may also be referred to as a third power rail for illustrative purposes. It should also be appreciated that RC triggered power clamp 100 of FIG. 2 (and subsequent figures) is used only for illustrative purposes, but does not limit the scope of the current invention. Other types of power clamps, e.g., voltage triggered power clamp, are also included in the current invention.

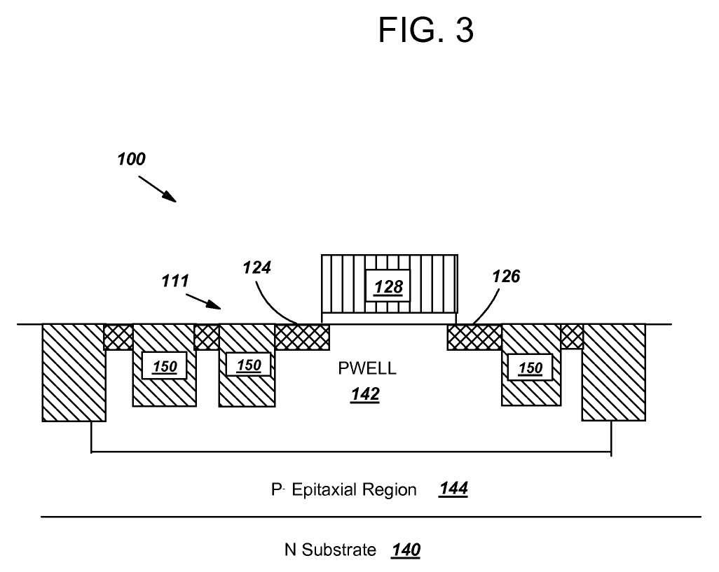

FIG. 3 shows a cross-sectional view of power clamp 100 of FIG. 2. As shown in FIG. 3, planar NFET 112 includes gate 128, source/drain diffusion regions 124,126 on the surface of active area 111. Shallow trench isolation (STI) regions 150 isolate diffusion regions 124, 126 from nearby structures of power clamp 100. P type well (PWELL) 142 that functions as the channel region of NFET 112 is not isolated by STIs 150. STI region 150 extends to a depth intermediate between a bottom of source/drain diffusion region 124/126 and a bottom of P type channel region/PWELL 142. A P-type epitaxial layer 144 exists between PWELL 142 and N-type substrate 140. As such, source 124, P-type epitaxial layer (region) 144 and N-substrate 140 constitute vertical NPN 130a (FIG. 2), and drain 126, P-type epitaxial layer 144 and N substrate 140 constitute vertical NPN 130b (FIG. 2).

In operation, ESD events can occur either on an input node circuitry (not shown), or between the power rails. In the case that ESD events occur on the input node circuitry, the ESD input circuitry is electrically couple to at least one power rail (typically two), e.g., first power rail 116, discharging current to the power rail. As is appreciated, given that third power rail 141 is coupled to N-substrate 140, there is typically no ESD direct path to third power rail 141 (FIG. 2). When an ESD event has positive polarity, ESD current is discharged to, e.g., first power rail 116 through ESD input elements such as diode elements. The current will then flow to the referenced (or electrically grounded) power rail, either second power rail 118 or third power rail 141.

In the case that the second power rail 118 is a referenced ground, triggering circuit (here, RC discriminator circuit) 114 responds to the ESD event, providing a signal to inverter chain 120, which subsequently causes the potential of NFET 11 2 to rise. This leads to an electrical “turn-on” of NFET 112, allowing the ESD event current flow from first power rail 116 to second power rail 118. As such, NFET 112 provides a channel to discharge ESD current between first power rail 116 and second power rail 118.

In the case that N-substrate (third) power rail 141 is a referenced ground, triggering circuit 114 responds to the ESD event, providing a signal to inverter chain 120, which subsequently causes the potential of NFET 112 to rise. This leads to the electrical “turn-on” of NFET 112, allowing the ESD event current flow from first power rail 116 to second power rail 118. However, since second power rail 118 is “floating”, no current actually flows to second power rail 118. Instead, vertical NPN device 130b formed between NFET 112 drain 126, P-epitaxy 144 and N-substrate 140 will allow discharge of current when the collector-to-emitter breakdown voltage with base open (BVCEO) of vertical NPN 130b occurs. Additionally NPN 130a formed between the NFET source 124, P-epitaxy 144 and N-substrate 140 will allow discharge of current when the BVCEO breakdown voltage of NPN 130a occurs. As such, NPN 130a provides a channel to discharge ESD current between first power rail 116 and third power rail 141; and NPN 130b provides a channel to discharge ESD current between second power rail 118 and third power rail 141.

In the case of ESD events between first power rail 116 and N-substrate (third) power rail 141, ESD current will flow from first power rail 116 to N-substrate power rail 141 through NPN 130a. For positive events, this will occur at the BVCEO breakdown voltage of vertical NPN 130a. For negative polarity events, NPN 130a will be in the forward active mode of operation.

In the case of ESD events between second power rail 118 and N-substrate power rail 141, ESD current will flow from second power rail 118 to N-substrate (third) power rail 141 through NPN transistor 130b. For positive events, this will occur at the BVCEO breakdown voltage of vertical NPN 130b. For negative polarity events, NPN 130b will be in the forward active mode of operation.

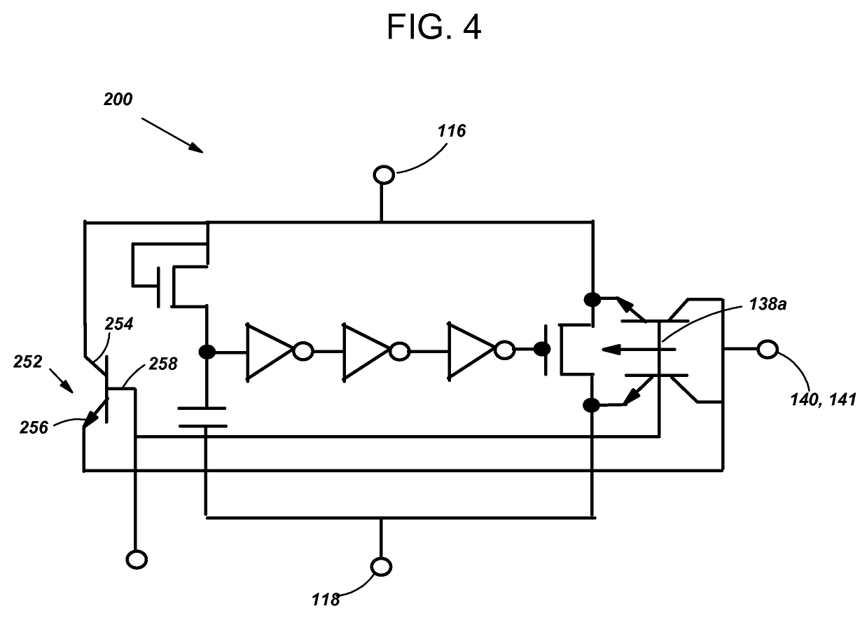

FIG. 4 shows an alternative embodiment of a power clamp 200 according to one embodiment of the invention. In addition to power clamp 100 of FIG. 2, power clamp 200 includes an additional vertical NPN device 252 coupled between first power rail 116 and substrate (third) power rail 141. Specifically, emitter 254 of NPN device 252 is coupled to first power rail 116; collector 256 of NPN device 252 is coupled/electrically short to third power rail 141; and base 258 of NPN device 252 is coupled to base pin 138 of NPN devices 130a, 130b.

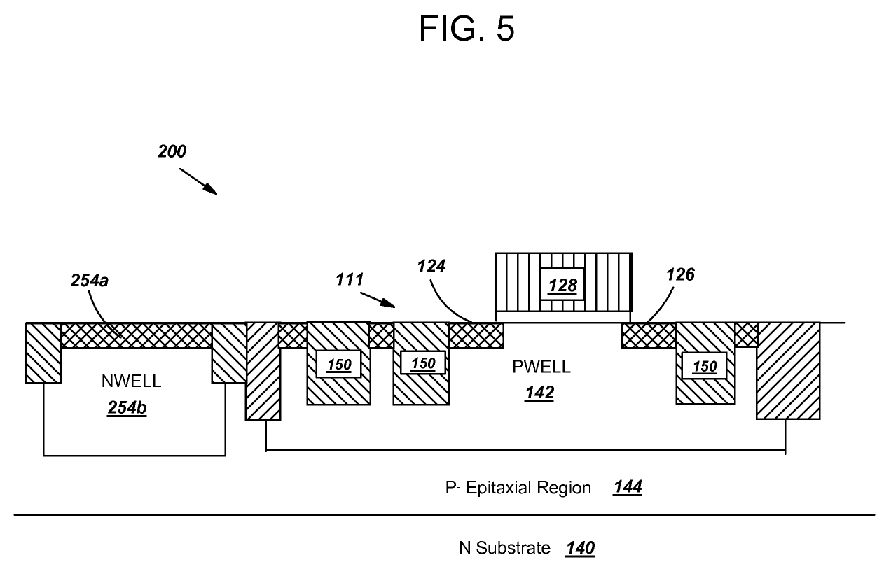

FIG. 5 shows a cross-sectional view of power clamp 200 of FIG. 4 according to one embodiment of the invention. As shown in FIG. 5, NPN 252 extends from silicon surface 111 to N type substrate 140 and includes in order: N+type diffusion region 254a (optional), N type well 254b, P-type epitaxial layer 144, and N type substrate 140. N+ type diffusion region 254a and N type well 254b together constitute emitter 254 (FIG. 4); P-type epitaxial layer 144 forms base 258 (FIG. 2); and N substrate 140 forms emitter 256 (FIG. 4).

In operation, besides the prior operational modes of power clamp 100 of FIG. 2, an additional ESD channeling function is provided through vertical NPN device 252. In the case of ESD events between first power rail 116 and N-substrate (third) power rail 141, ESD current will flow from first power rail 116 to N-substrate (third) power rail 141 through NPN device 252. For positive polarity events, this will occur at the BVCEO breakdown voltage of vertical NPN device 252. For negative polarity events, vertical NPN device 252 will be in the forward active mode of operation.

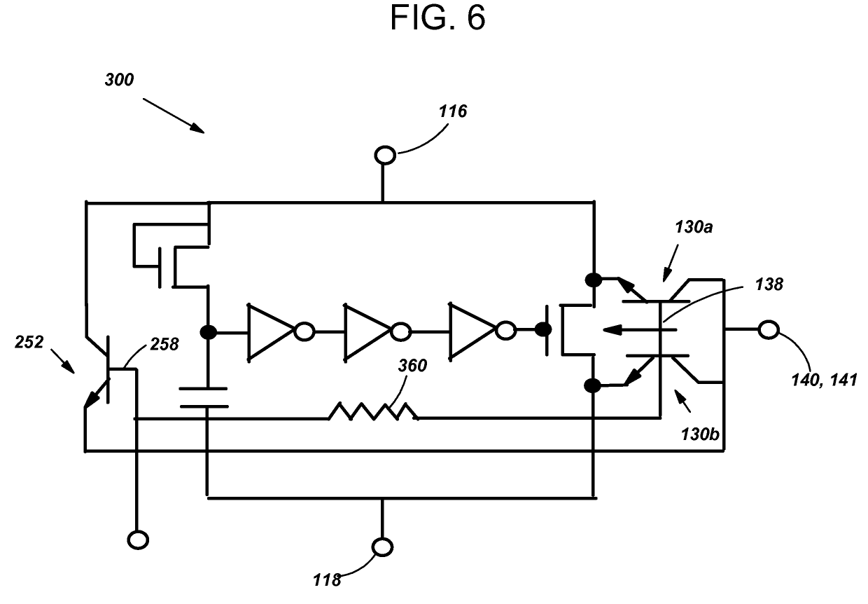

FIG. 6 shows another alternative embodiment of a power clamp 300 according to the invention. As shown in FIG. 6, in addition to power clamp 200 of FIG. 4, power clamp 300 includes a “pinch” resistor 360 coupled between base 258 and base pin 138. The “pinch” resistor may be effected by forming a small channel in P-epitaxy region 144 between N-well 254b and the N-substrate 140 (FIG. 5). As such, N type well 254b, P-type epitaxial region 144, and N-type substrate 140 constitute pinch resistor 360.

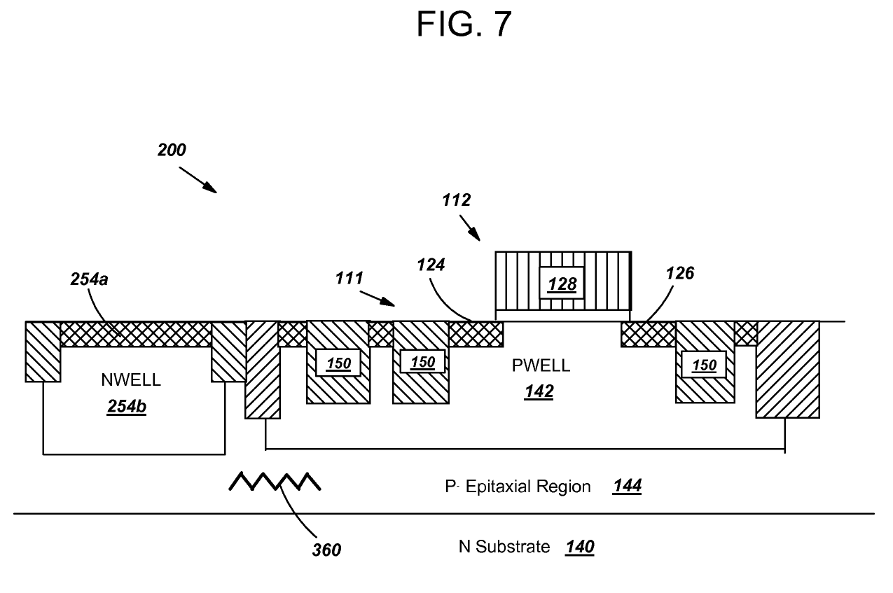

FIG. 7 shows a cross-sectional view of power clamp 300 of FIG. 6 according to one embodiment of the invention. As shown in FIG. 7, a resistive region/resistor 360 is deposited within P-type epitaxial region 144 and between N-well 254b and the N-substrate 140. It should be appreciated that any methods may be used to deposit resistor/resistive region 360 within P-type epitaxial layer 144, or to increase the resistance of part of P-type epitaxial layer 144 to affect resistor 360.

In operation, resistor 360 may function as a body modulator to perform dynamic threshold MOSFET (DTMOS) modulation and MOSFET snapback modulation of NFET 112. Additionally, resistor 360 may function to modulate the collector-to-emitter breakdown voltage with specified resistance from emitter to base resistance (BVCER voltage) of vertical NPN devices 130a, 130b.

Specifically, when bias occurs on the two N-doped regions, i.e., N-well 254b and the N-substrate 140, resistor 360 value increases, which modulates the substrate potential of channel region (PWELL) 142 of NFET 112. As the potential of the NFET 112 drain/source 124,126 increases, substrate current flows into the MOSFET body, which allows the voltage of NFET 112 channel 142 to rise. As NFET 112 channel body 142 voltage rises, the threshold voltage of NFET 112 decreases, leading to an earlier turn-on of the MOSFET device when NFET 112 gate 128 potential exceeds the threshold voltage (dynamic threshold voltage). Additionally, as NFET 112 threshold voltage decreases, NFET 112 current drive increases. In operation, when an ESD event occurs on first power rail 116, NFET drain 126 voltage increases, which leads to a lowering of the MOSFET threshold voltage, and an early turn-on of NFET 112 discharging the ESD to second power rail 118.

In the case that the N-substrate (third) power rail 141 is grounded, vertical NPN transistors 130a, 130b provides ESD functions. In this case, for positive polarity events, the ESD current flows to N-substrate power rail 141 at the collector-to-emitter breakdown voltage with specified resistance from emitter to base (BVCER). As pinch resistor 360 increases, BVCER voltage is modulated because BVCER voltage is a function of base resistance.

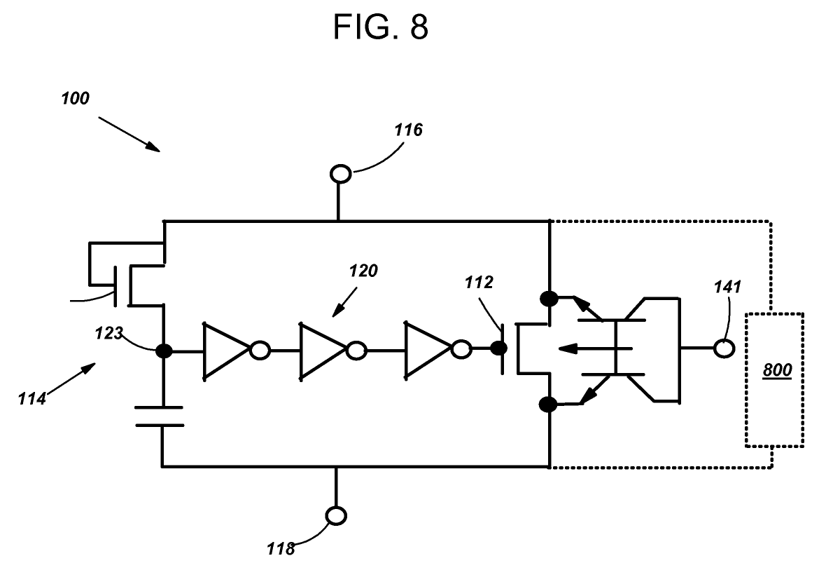

FIG. 8 shows a circuit structure of an implementation of the power clamps of the invention to protect target circuit 800 from ESD pulses. As shown in FIG. 8, power clamp 100 is coupled between first power rail 116 and second power rail 118 in parallel to circuit 800. In operation, triggering circuit 114 generates a voltage at interconnect 123 in response to an ESD pulse. The voltage may be translated by inverter chain 120 to render NFET 112 conductive. As such, the ESD pulse is channeled to a by-pass circuit 800.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A structure in a power clamp system, the structure comprising:
a planar n-channel field effect transistor (NFET) on a surface of the structure;
a P-type epitaxial region under a P-type channel region of the NFET; and
an N-type substrate under the P-type epitaxial region;
wherein a diffusion region of the NFET, the P-type epitaxial region, and the N-type substrate constitute a vertical NPN device.

2. The structure of claim 1, wherein the diffusion region of the NFET is a source.

3. The structure of claim 1, wherein the diffusion of the NFET is a drain.

4. The structure of claim 1, further comprising an N-type well in the P-type epitaxial region, wherein the N type well, the P-type epitaxial region, and the N-type substrate constitute a vertical NPN device.

5. The structure of claim 1, further comprising an N-type well in the P-type epitaxial region wherein the N type well, P-type epitaxial region, and the N-type substrate constitute a vertical pinch resistor device.

6. The structure of claim 5, wherein a resistive region is formed within the P type epitaxial region, wherein the P-type epitaxial region is a base of the vertical pinch resistor device.

7. A method of protecting a target circuit from an electrostatic discharge (ESD), the method comprising:
coupling a power clamp system between a first power rail and a second power rail in parallel to the target circuit, the power clamp system including:
an n-channel field effect transistor (NFET), a source pin and a drain pin of the NFET electrically coupled to the first power rail and the second power rail, respectively; and
a first vertical NPN device coupled between one of the source pin and the drain pin of the NFET and a third power rail.

8. The method of claim 7, wherein the first vertical NPN device provides a channel to discharge the ESD between one of:
the first power rail and the third power rail; and
the second power rail and the third power rail.

9. The method of claim 7, wherein the power clamp system further includes a second vertical NPN device coupled between the other one of the source and the drain pin of the NFET and the third power rail, wherein the second vertical NPN device provides a channel to discharge the ESD between the other one of:
the first power rail and the third power rail; and
the second power rail and the third power rail.

10. The method of claim 7, wherein the NFET provides a channel to discharge the ESD between the first power rail and the second power rail.

11. The method of claim 7, wherein the power clamp system further includes a second vertical NPN device coupled between the first power rail and the third power rail, wherein the second vertical NPN device provides a channel to discharge ESD between the first power rail and the third power rail.

12. The method of claim 7, wherein the power clamp system further includes a pinch resistor to electrically modulate a resistance of a P-type epitaxial region under the NFET to provide a dynamic threshold voltage modulation and a snapback response modulation of the NFET.

13. The method of claim 12, wherein the pinch resistor further electrically modulates the P-type epitaxial region resistance to provide a variable collector-to-emitter breakdown voltage with specified resistance from emitter to base (BVCER breakdown voltage) of the first vertical NPN transistor.

14. A power clamp system, the power clamp system comprising:
an n-channel field effect transistor (NFET), a source pin and a drain pin of the NFET electrically coupled to the first and the second power rails, respectively; and
a first vertical NPN device coupled between one of the source pin and the drain pin of the NFET and a third power rail.

15. The power clamp system of claim 14, wherein the first vertical NPN device provides a channel to discharge ESD between one of:
the first power rail and the third power rail; and
the second power rail and the third power rail.

16. The power clamp system of claim 14, further including a second vertical NPN device coupled between the other one of the source and the drain pin of the NFET and the third power rail, wherein the second vertical NPN device provides a channel to discharge ESD between the other one of:
the first power rail and the third power rail; and
the second power rail and the third power rail.

17. The power clamp system of claim 14, wherein the NFET provides a channel to discharge ESD between the first and the second power rail.

18. The power clamp system of claim 14, further including a second vertical NPN device coupled between the first power rail and the third power rail, wherein the second vertical NPN device provides a channel to discharge ESD between the first power rail and the third power rail.

19. The power clamp system of claim 14, further including a pinch resistor to electrically modulate a resistance of a P-type epitaxial region under the NFET to provide a dynamic threshold voltage modulation and a snapback response modulation of the NFET.

20. The power clamp system of claim 19, wherein the pinch resistor further electrically modulates the P-type epitaxial region resistance to provide a variable collector-to-emitter breakdown voltage with specified resistance from emitter to base (BVCER breakdown voltage) of the first vertical NPN transistor.
